(19) United States
(12) Patent Application Publication
(10) Pub. No.: US 2011/0153972 A1
(43) Pub. Date: Jun. 23, 2011

(54) FREE SPACE DEFRAGMENTION IN EXTENT BASED FILE SYSTEM

(75) Inventor: Tim LaBERGE, St. Paul, MN (US)

(73) Assignee: QUANTUM CORPORATION, San Jose, CA (US)

(21) Appl. No.: 12/645,530

(22) Filed: Dec. 23, 2009

(51) Int. Cl. G06F 12/02; G06F 12/00

(52) U.S. Cl. 711/165; 711/170; 711/171; 711/E12.001; 711/E12.002

(57) ABSTRACT

Example apparatus, methods, data structures, and computers defragment unallocated space in a storage associated with an extent based file system. One example method locates a first unallocated area having a desired size and a desired location to receive an extent from a first end of an allocated area in the storage. The example method then swaps the extent from the first end of the allocated area with the first unallocated area. The example method also locates a second unallocated area having a desired size and a desired location to receive an extent from a second opposite end of the allocated area in the storage. The example method then swaps the extent from the second end of the allocated area with the second unallocated area. The example method may continue to swap until no more suitable unallocated regions are available to receive an extent sliced off an allocated area.

### BACKGROUND

Storage systems, memory, and file systems experience the well known phenomenon that the free space in these systems becomes fragmented. File system storage is typically organized into a sequence of fixed size blocks. The fixed size blocks may include a fixed number of physical storage (e.g., disk, memory, tape) blocks. The fixed size blocks are typically indexed by logical block numbers. Space can either be allocated or unallocated. Unallocated space may also be referred to as free space. Free space can become fragmented as files and space are allocated, de-allocated, relocated, truncated, and expanded. Free space fragmentation can negatively impact file system performance by making it more difficult to allocate contiguous space and by making it more difficult to track allocated space.

When a new item to be stored is presented to, for example, a file system, the file system will typically search for space to store the new item. If free space has become fragmented to the point where there are no unallocated regions large enough to receive the new item, then multiple locations will need to be allocated. Having large contiguous ranges of free space can make allocating space for a new item logically simpler in that a single allocation is performed. In block based systems, a single allocation of space can require multiple allocations of blocks. Allocating multiple small ranges of free space for the new item is logically and physically more complicated than allocating one continuous range of space. Additionally, keeping track of an item stored in several smaller non-contiguous spaces is conceptually and physically more difficult than keeping track of an item stored in one large contiguous space.

One traditional approach for dealing with fragmented free space involved adding more space and performing new allocations from the additional space. Since the additional space was previously unused, large contiguous ranges of free space were available to simplify allocation and tracking. Another traditional approach for dealing with fragmented free space involved adding more space and rewriting currently allocated areas into the additional new space in a manner that reduced free space fragmentation. The space from which the allocated areas were written would become larger contiguous unallocated spaces and the space to which the allocated areas were written would have the leftover free space as contiguous free space.

### BRIEF DESCRIPTION OF THE DRAWINGS

The accompanying drawings, which are incorporated in and constitute a part of the specification, illustrate various example methods, apparatuses, and other example embodiments of various aspects of the invention described herein. It will be appreciated that the illustrated element boundaries (e.g., boxes, groups of boxes, other shapes) in the figures represent one example of the boundaries of the elements. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a storage associated with an extent-based file system, where the storage has an allocated area and an unallocated area.

FIG. 2 illustrates data structures associated with defragmenting free space in a storage associated with an extent-based file system.

FIG. 3 illustrates a data structure associated with defragmenting free space in a storage associated with an extent-based file system.

FIG. 4 illustrates allocated areas and unallocated areas in a storage associated with an extent-based file system.

FIG. 5 illustrates allocated areas and unallocated areas in a storage associated with an extent-based file system.

FIG. 6 illustrates allocated areas and unallocated areas in a storage associated with an extent-based file system.

FIG. 7 illustrates a flowchart of a method associated with defragmenting free space in a storage associated with an extent-based file system.

FIG. 8 illustrates a flowchart of a method associated with defragmenting free space in a storage associated with an extent-based file system.

FIG. 9 illustrates an apparatus configured to defragment free space in a storage associated with an extent-based file system.

FIG. 10 illustrates allocated areas and unallocated areas in a storage associated with an extent-based file system.

FIG. 11 illustrates allocated areas and unallocated areas in a storage associated with an extent-based file system.

### DETAILED DESCRIPTION

Example apparatus and methods defragment free space in a storage (e.g., memory, disk, tape) associated with an extent-based file system. Rather than allocating and tracking storage on an individual basis, extent-based systems track storage on an extent basis. An extent is a contiguous set of blocks associated with a file. The blocks may be contiguous in a file and also on an underlying block storage device. An extent based file system may only store three pieces of information for an extent. The three pieces include a starting block for the extent, a file relative offset, and how many contiguous blocks are in the extent. This facilitates reducing the amount of metadata stored for a file because a single extent can replace a large number of block pointers. A file may be stored in one or more extents. Performance improvements for extent-based systems are increased when data can be stored in contiguous blocks.

Example apparatus and methods may identify allocated extents to be relocated from an allocated area to an unallocated area and then swap the allocated extent and the unallocated area in a transaction or transaction-like operation. In one example, multiple extents may be identified and then multiple processes and/or processors may swap the allocated extents and the unallocated areas in parallel. Performing the defragmentation in parallel facilitates reducing defragmentation time.

One example extent-based filed system is the StorNext File System (SNFS). SNFS is a shared-disk file system. SNFS is employed on hosts that are connected to the same disk array in a storage area network (SAN). SNFS supports environments in which large files are shared by users who prefer to avoid network delays (e.g., real time satellite image data), and supports environments where a file is made available for access by multiple readers starting at different times (e.g., on-demand movie access). SNFS supports the StorNext Storage Manager, which is a hierarchical storage management (HSM) system. An HSM automatically moves data between different storage media (e.g., memory, disk, tape, tape library, optical disk) having different properties (e.g., write speed, read time, cost per byte stored). In operation an HSM may treat fast disk drives as caches for slower mass storage devices. An HSM may monitor data usage and probabilistically relocate data based on the monitoring. Relocating files can lead to free space fragmentation.

Space in SNFS is allocated out of stripe groups. A stripe group logically represents a storage pool that is indexed by file system block number. An allocation in a stripe group is described by an extent in an Mode. An extent can include, for example, a file relative offset that describes where the extent fits into a file, a physical block that describes the physical location of the first block in the extent, and an allocation length that describes the number of blocks in the extent. Data striping is a technique where sequential data is logically segmented. For example, a single file can be segmented so that segments can be assigned to multiple physical devices to facilitate reading and/or writing from multiple devices in parallel.

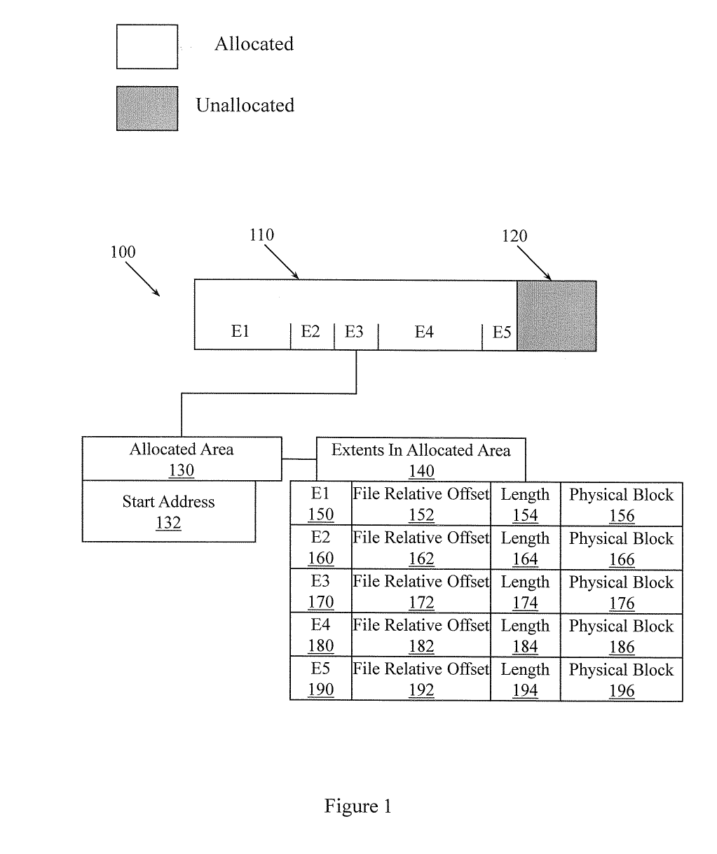

FIG. 1 illustrates a storage 100. Storage 100 can be associated with an extent-based file system. The storage 100 has an allocated area 110 and an unallocated area 120. The allocated area 110 is illustrated as having five extents labeled E1, E2, E3, E4, and E5. The unallocated area 120 does not have an extent. The storage 100 can be located in, for example, a disk, a set of disks, a memory, a set of memories, and other storage devices.

An extent-based file system may maintain a data structure 130 that tracks allocated areas. The data structure 130 may include an entry 132 that stores the start addresses of allocated areas. Example apparatus and methods may also maintain a data structure 140 that tracks extents present in the allocated areas. Data structure 140 is illustrated storing one entry per extent. An entry may include a file relative offset that describes where the extent fits into a file. An entry may also include a length that describes how many blocks are in the extent and a physical block entry that describes a physical address for a marker block (e.g., first block) in an extent. For example, entry 150 stores information concerning extent E1. The information includes a file relative offset 152, a length 154, and a physical block 156. Similarly, entry 160 stores information concerning extent E2, the information including a file relative offset 162, a length 164, and a physical block 166. Additional entries store information for other extents. For example, entry 170 stores information concerning extent E3 (e.g., file relative offset 172, length 174, physical block 176), entry 180 stores information concerning extent E4, (e.g., file relative offset 182, length 184, physical block 186), and entry 190 stores information concerning extent E5, (e.g., file relative offset 192, length 194, physical block 196).

FIG. 1 illustrates that a storage 100 can have allocated areas and unallocated areas. An allocated area may store information associated with different extents. The different extents may be associated with different files stored by a file system. While an extent based file system may track the allocated areas, example apparatus and methods may also track additional information at the extent level. An extent may have one or more (e.g., 65, 536) blocks of data, where a block of data corresponds to the basic input/output unit size or the basic storage size.

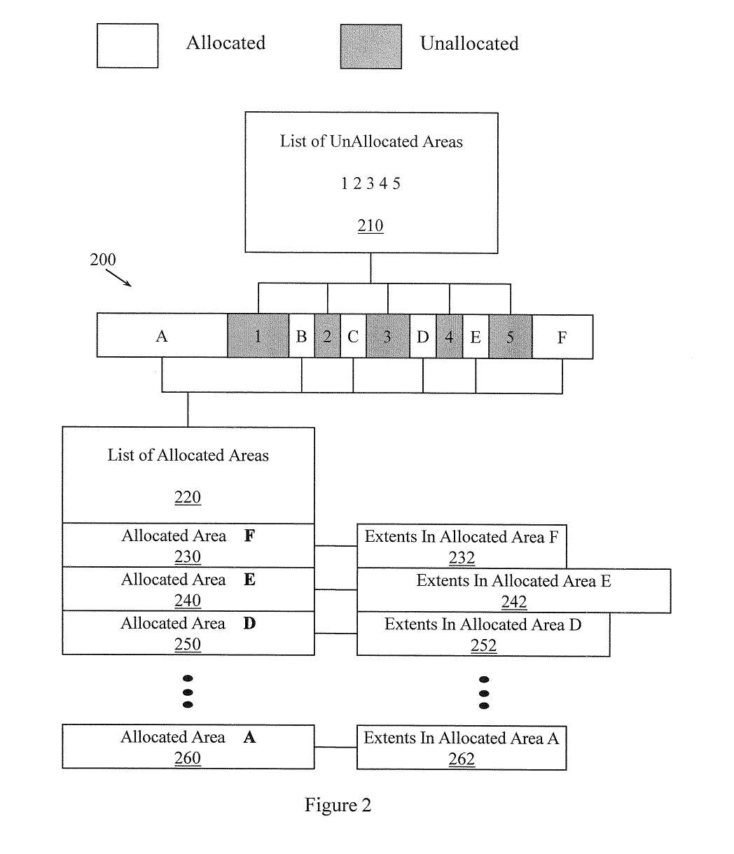

FIG. 2 illustrates data structures associated with defragmenting free space in a storage associated with an extent-based file system. FIG. 2 illustrates a storage 200 that has allocated areas A, B, C, D, E, and F and that also has unallocated areas 1, 2, 3, 4, and 5. FIG. 2 illustrates a data structure 210 that has one entry for each unallocated area. Data structure 210 stores the entries in a list sorted from lowest physical address to highest physical address. Therefore the first entry corresponds to the first unallocated area. FIG. 2 also illustrates a data structure 220 that has one entry for each allocated area. Data structure 220 stores the entries in a list sorted from highest physical address to lowest physical address. Therefore the first entry corresponds to the last allocated area. One skilled in the art will appreciate that different data structures may be organized in different ways.

Data structure 220 includes an entry 230 for allocated area F. This entry includes information 232 about extents in allocated area F. Recall that an allocated area may have one or more extents associated with it. Data structure 220 also includes an entry 240 for allocated area E. This entry includes information 242 about extents in allocated area E. Data structure 220 also includes an entry 250 for allocated area D. This entry includes information 252 about extents in allocated area D. Data structure 220 also includes an entry 260 for allocated area A. This entry includes information 262 about extents in allocated area A.

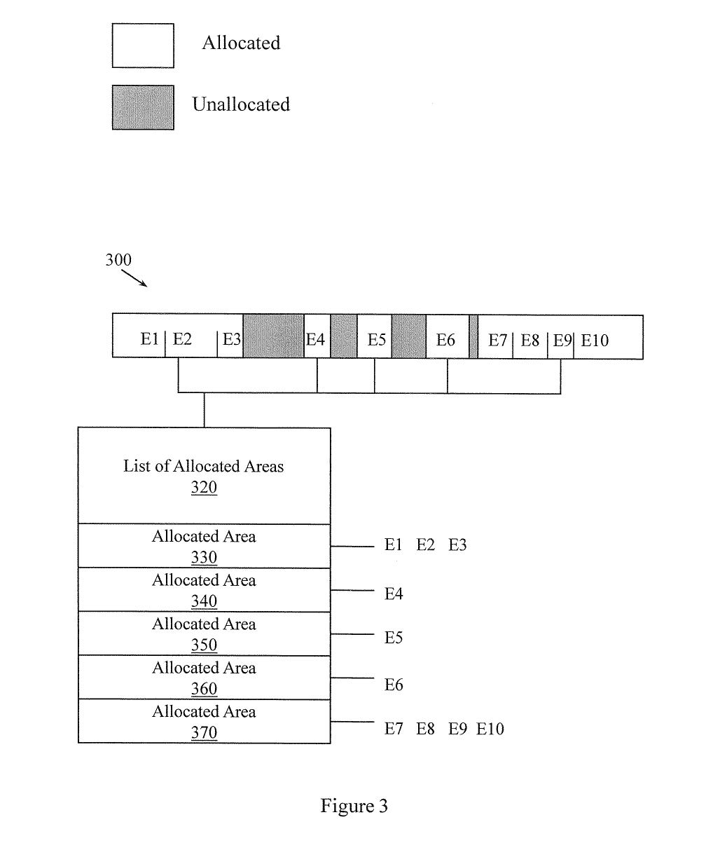

While FIG. 2 looks at storage from the allocated area point of view, FIG. 3 looks at storage more from the extent point of view. FIG. 3 illustrates a data structure 320 associated with defragmenting free space in a storage associated with an extent-based file system. Data structure 320 stores information about allocated areas in storage 300. Data structure 320 also stores information about extents in storage 300. A first entry 330 in data structure 310 stores information about an allocated area and stores the fact that the allocated area is associated with extents E1, E2, and E3. A second entry 340 in data structure 310 stores information about another allocated area and stores the fact that the allocated area is associated with extent E4. Another entry 350 in data structure 310 stores information about an allocated area and stores the fact that the allocated area is associated with extent E5. Another entry 360 in data structure 310 stores information about an allocated area and stores the fact that the allocated area is associated with extent E6. Another entry 370 in data structure 310 stores information about an allocated area and stores the fact that the allocated area is associated with extents E7, E8, E9, and E10. One skilled in the art will appreciate that different extents may be associated with different files. For example, a first file may be stored in extents E1, E4 and E10 while a second file may be stored in extents E2, E3, E6, and E8.

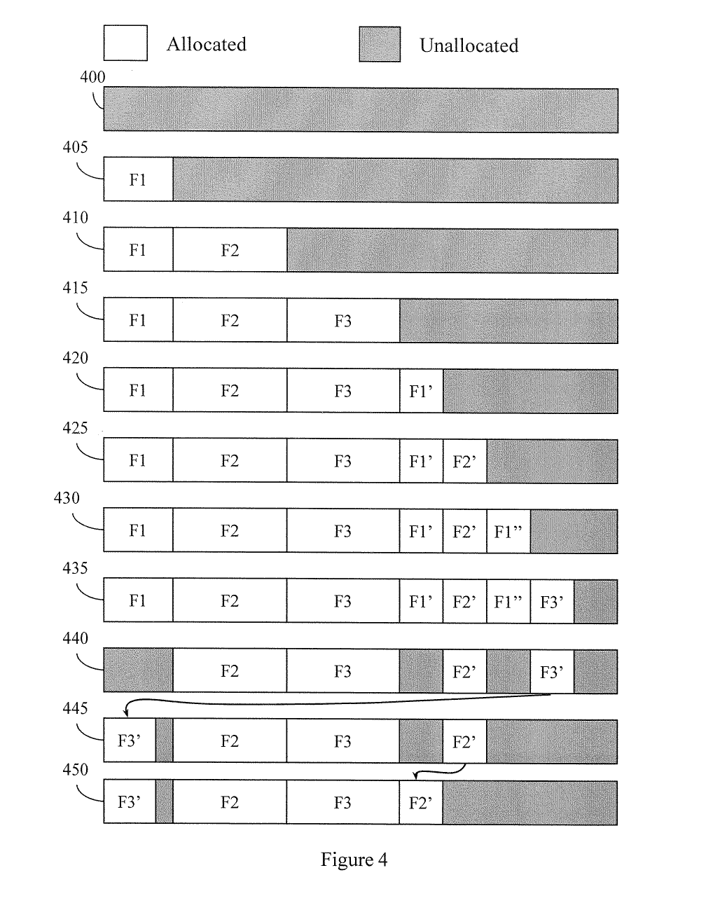

FIG. 4 illustrates changes occurring over time in allocated areas and unallocated areas in a storage associated with an extent-based file system. Initially, at time 400, there is one large unallocated space. At time 405, a file F1 is added to the storage. Adding file F1 reduces the amount of unallocated space. At time 410, a second file F2 is added to the storage. Since there is a large contiguous unallocated space, adding the second file to the storage requires one allocation. At time 415, a third file F3 is added to the storage. The storage is filling up, but there still remains a large contiguous unallocated area.

At time 420, updates to file F1 are added (e.g., F1′). Since there is no free space right beside where file F1 is already stored, the updates are added in an unallocated area. A file system that is tracking file F1 would therefore track the fact that two extents are associated with file F1. The file system, if it was tracking allocated areas, would also note that there is one allocated area that has three files and four different extents associated with it. At time 425, updates to file F2 are added (e.g., F2′). At time 430, more updates to file F1 are added (e.g., F1″). At time 435, updates to F3 are added (e.g., F3′). So far all the activity has involved adding items to the file system, which has had the effect of filling up the storage and reducing the amount of unallocated space. However, the unallocated space has not become fragmented at all. The remaining unallocated space is still in one contiguous area.

At time 440, file F1 is deleted from the file system. This results in more unallocated space. This also results in there being four separate non-contiguous unallocated areas.

Example apparatus and methods facilitate creating larger, contiguous unallocated areas from smaller non-contiguous areas. Between times 440 and 445, the extent(s) associated with F3′ were relocated from one allocated area on the right side of 440 to the unallocated area on the left side of 440. While this reduces the size of the unallocated area on the left of 440, this increases the size of the unallocated area on the right of 440. Comparing 440 to 445 shows that the number of unallocated areas has been reduced from four to three and shows that the largest unallocated area is larger. Between times 445 and 450, the extent(s) associated with F2′ are relocated further left. In this movement, the extent(s) associated with F2′ fit an unallocated area exactly. The relocation results in a decrease in the number of unallocated regions and an increase in the largest contiguous unallocated area. Example apparatus and methods therefore produce larger, contiguous unallocated areas, tend to collect allocated extents in one region of storage, and may reduce the number of unallocated areas because extents are not split, they are simply swapped into previously unallocated areas.

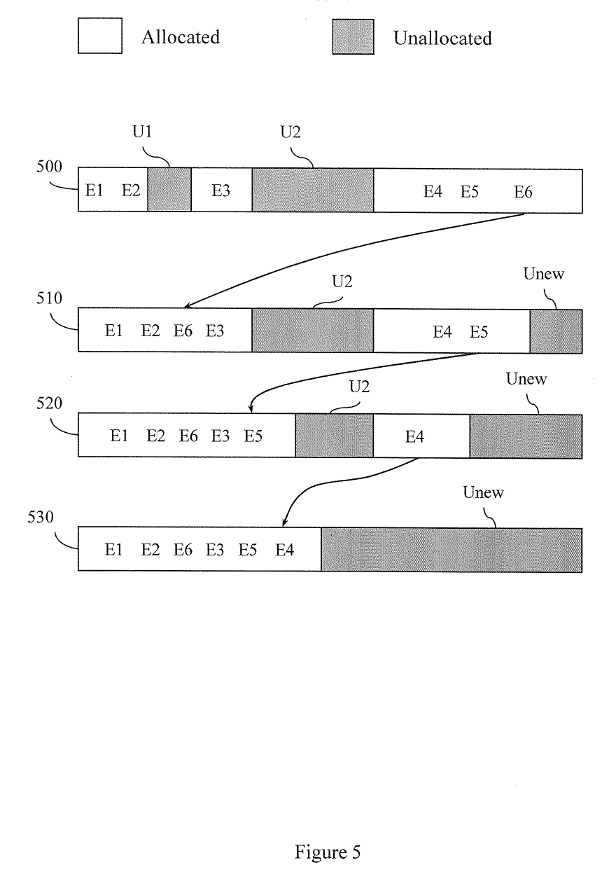

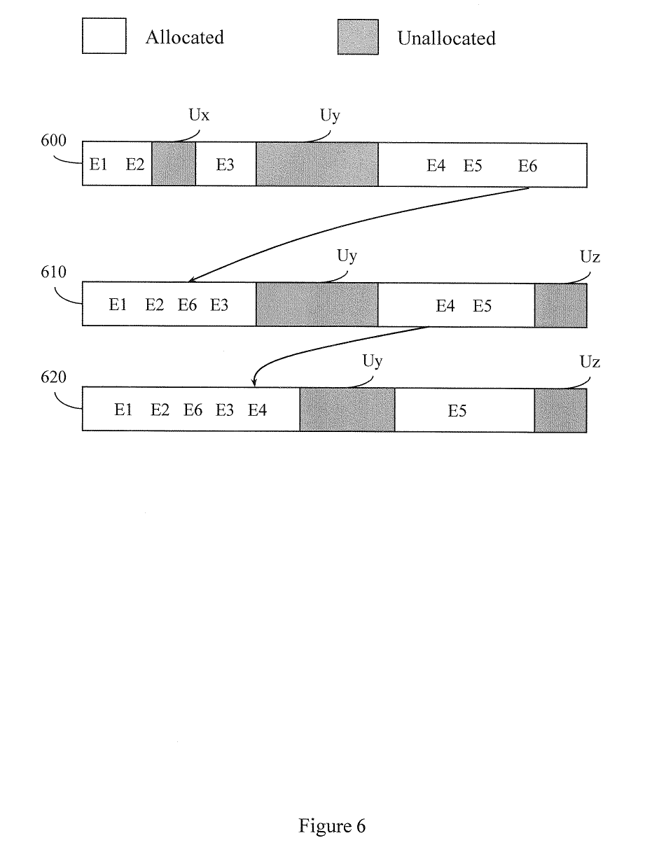

FIG. 5 illustrates re-arranging allocated areas and unallocated areas in a storage associated with an extent-based file system, where the storage is processed by example apparatus and methods. At time 500, a storage has three allocated areas and two unallocated areas. The first allocated area has two extents (E1, E2), the second allocated area has one extent (E3), and the third allocated area has three extents (E4, E5, E6). In one example, extents are sliced off the ends of allocated areas and moved to best fitting unallocated areas. In one example, extents from the highest addressed allocated area are moved into the lowest addressed, best fitting unallocated area. Extents are not split. By way of illustration, between times 500 and 510, extent E6 is sliced off the back end of the third allocated area and swapped into the leftmost unallocated area U1. There was a perfect fit and thus the unallocated area U1 disappears. However, a new unallocated area Unew appears where extent E6 had previously resided. Between times 510 and 520, extent E5 is sliced off the back end of the third allocated area (which is now actually the second allocated area) and swapped into the lowest addressed, best fitting unallocated region of U2. This reduces the size of the first unallocated area U2, but increases the size of the second (rightmost) unallocated area Unew. Between times 520 and 530, extent E4 is sliced off the back of the third allocated area (which is now the second allocated area), and moved into the leftmost, best fitting unallocated area of U2. By time 530, when the example apparatus and method are done, one large contiguous unallocated area Unew is produced. One skilled in the art will appreciate that FIG. 5 illustrates a highly simplified example and that other extent slicing approaches may be taken. FIG. 6 illustrates another example extent slicing approach.

FIG. 6 illustrates re-arranging allocated areas and unallocated areas in a storage associated with an extent-based file system, where the storage is processed by example apparatus and methods. At time 600, the storage has three allocated areas and two unallocated areas. The first allocated area is associated with extents E1 and E2. The second allocated area is associated with extent E3, and the third allocated area is associated with extents E4, E5, and E6. Between times 600 and 610, extent E6 is sliced off the back end of the third allocated area and swapped into the left most, best fitting unallocated area Ux. There is a perfect fit between E6 and Ux. Between times 610 and 620, extent E4 is sliced off the front of the third allocated area (which is now actually the second allocated area) and swapped into the left most, best fitting unallocated area in Uy. Uy remains the same size because the area allocated to receive E4 equals the amount of space that is now unallocated because E4 vacated the area. There was no unallocated region large enough to accept E5 if it was sliced off the back of the allocated area.

Having briefly illustrated some examples of storages, allocated areas, unallocated areas, and rearranging extents in the storage, example methods and apparatus that will now be described in greater detail.

The following includes definitions of selected terms employed herein. The definitions include various examples and/or forms of components that fall within the scope of a term and that may be used for implementation. The examples are not intended to be limiting.

References to “one embodiment”, “an embodiment”, “one example”, “an example”, and other similar terms indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” or “in one example” does not necessarily refer to the same embodiment or example.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations include physical manipulations of physical quantities. Usually, though not necessarily, the physical quantities take the form of electrical or magnetic signals capable of being stored, transferred, combined, compared, and otherwise manipulated in a logic. The physical manipulations transform electronic components and/or data representing physical entities from one state to another.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks.

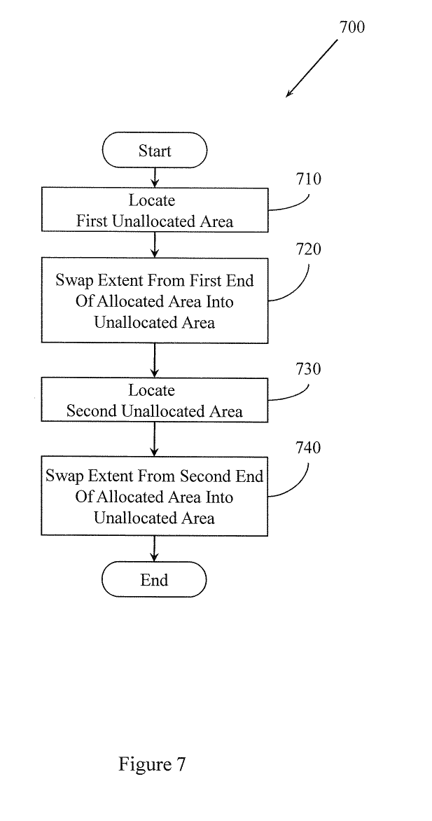

FIG. 7 illustrates a method 700. Method 700 controls a computer to perform a free space defragmentation method for free space in a storage associated with an extent-based file system. The file system may be, for example, a distributed file system. Method 700 includes, at 710, locating a first unallocated area having a desired size and a desired location to receive an extent from a first end of an allocated area in the storage. Once the first unallocated area is located at 710, then method 700 continues, at 720, by swapping the extent from the first end of the allocated area with the first unallocated area.

Method 700 also includes, at 730, locating a second unallocated area having a desired size and a desired location to receive an extent from a second opposite end of the allocated area in the storage. Once the second unallocated area is located at 730, method 700 continues, at 740, by swapping the extent from the second end of the allocated area with the second unallocated area.

One skilled in the art will appreciate that actions 710 through 740 may be repeated a number of times until a termination condition is satisfied. For example, actions 710 through 740 may continue until there are no more unallocated areas suitable for receiving extents that could be carved off the front or end of an allocated area. Or, actions 710 through 740 may continue until there are no extents left to move.

In one example, the first unallocated area and the second unallocated area are determined as a function of a best fit selection strategy. Using a best fit selection strategy facilitates insuring that fragmentation will not be made worse by the defragmentation process. Consider an extent that is 10k in size. There may be several unallocated areas located in a desired region (e.g., before, after) relative to the allocated area. One unallocated area may be 100k in size, another may be 500k in size, and another may be 10k in size. In the best fit example, the 10k extent would be moved to the 10k unallocated region. In this example, there would have been no temptation to split the extent. In an exact fit example, the 10k extent would also be moved to the 10k unallocated area. However, if the extent was 10k in size, and the unallocated areas were 1k, 5k, and 2k, and 3k in size, then some conventional systems would have split the extent and stored it in the first available 10k combination of the unallocated areas. Example apparatus and methods do not split extents to avoid producing file fragmentation while reducing free fragmentation. In an exact fit example, if the unallocated areas were 1k, 20k, and 100k in size, then the extent would not be moved because there is no exact fit. In a best fit example, if the unallocated areas were 1k, 20k, and 100k, then the extent could not be moved to the 1k area because it is too large. However, the 10k extent could be moved to the 20k area or to the 100k area depending on how the best fit process was configured or it could be left in place depending on how the best fit process was configured.

In one example, the first unallocated area and the second unallocated area are required to maintain a desired spatial relationship with the allocated area. For example, extents may be swapped with unallocated regions located before the extent or with unallocated regions located after the extent. This facilitates collecting extents at one end or the other end of a storage, which in turn facilitates producing larger, contiguous free spaces at the end opposite to where the extents are being moved.

In one example, the identifying and the swapping may proceed in parallel and/or substantially in parallel. Therefore, action 710 may be performed a number of times before any extents are swapped. Similarly, action 730 may be performed a number of times before any extents are swapped. While extents are waiting to be swapped, and while an unallocated region is waiting to receive an extent, both may be marked in a way that prevents a file system from using either the extent or the unallocated area until the swap is complete. When the movements are undertaken, they may be performed as a transaction.

In one example, a method may be implemented as computer executable instructions. Thus, in one example, a computer readable medium may store computer executable instructions that if executed by a computer (e.g., data reducer) cause the computer to perform method 700. While executable instructions associated with the above method are described as being stored on a computer readable medium, it is to be appreciated that executable instructions associated with other example methods described herein may also be stored on a computer readable medium.

“Computer readable medium”, as used herein, refers to a medium that stores signals, instructions and/or data. A computer readable medium may take forms, including, but not limited to, non-volatile media, and volatile media. Non-volatile media may include, for example, optical disks, and magnetic disks. Volatile media may include, for example, semiconductor memories, and dynamic memory. Common forms of a computer readable medium may include, but are not limited to, a floppy disk, a flexible disk, a hard disk, a magnetic tape, other magnetic medium, an ASIC, a CD (compact disk), other optical medium, a RAM (random access memory), a ROM (read only memory), a memory chip or card, a memory stick, and other media from which a computer, a processor, or other electronic device can read.

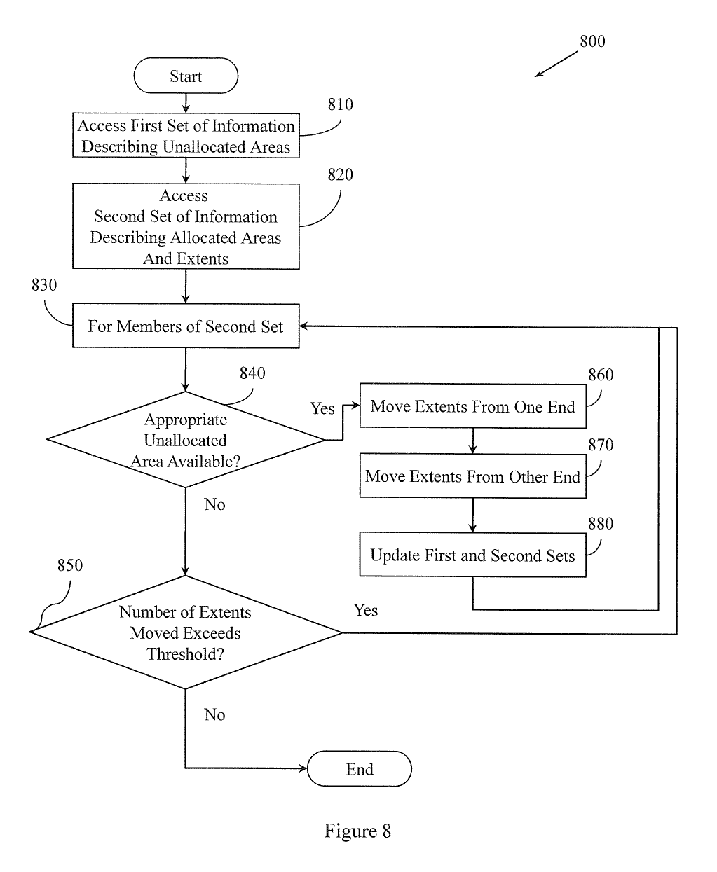

FIG. 8 illustrates a method 800. Method 800 controls a computer to perform a free space defragmentation method for free space in a storage associated with an extent-based file system. Method 800 includes, at 810, accessing a first sorted set of information that describes unallocated areas in a storage associated with an extent-based file system. The first sorted set of information may be organized to facilitate aggregating unallocated space at locations including the start (e.g., lowest addresses) or the end (e.g., highest addresses) of the storage.

Method 800 also includes, at 820, accessing a second sorted set of information that describes allocated areas in the storage. A member of the second set of information includes identifiers of extents in an allocated area of the storage associated with the member. The second sorted set of information may also be organized to facilitate aggregating allocated extents at locations including the start (e.g., lowest addresses) or the end (e.g., highest addresses) of the storage.

There may be multiple allocated areas, each of which may have multiple extents. Additionally, there may be multiple unallocated areas. Therefore, actions 840 through 880 may be performed a number of times. In one example, method 800 determines, at 830, to perform the “identify, slice, and swap” actions of 840 through 880 for each member of the second set of information. In other examples (e.g., partial defragmentation) a pre-determined number of members of the second set of information may be processed, a pre-determined amount of time may be allocated to defragmentation, defragmentation may proceed while less than a threshold amount of file system activity is occurring, and so on.

To move an extent, a suitable location must be available. Therefore, method 800 includes, at 840, determining whether an appropriate unallocated area is available. Being appropriate can depend on size and location relative to an extent being moved.

If no appropriate location is available, then method 800 may determine, at 850, whether a threshold number of extents were moved from an allocated area of the storage to an unallocated area of the storage during the repetitions of actions 840 through 880. If the determination is Yes, then the method 800 may terminate. Otherwise another pass may be made through the repetitions.

Returning to action 840, finding an appropriate location depends on knowing which extent is being considered for slicing from an allocated region. Therefore the determination at 840 can include selecting a member of the second sorted set of information and then selecting a first extent associated with the member. Method 800 slices extents off the ends of an allocated region. Therefore, in one iteration, the first extent is the terminal extent at a first end of the allocated area associated with the member. In another iteration, the determination at 840 can include selecting a second extent associated with the member, where the second extent is the terminal extent at a second, opposite end of the allocated area.

Upon determining at 840 that an unallocated area large enough to store the first extent exists in the storage and is located in a desired region relative the first extent in storage, method 800 may proceed, at 860, to move the first extent from the first end of the allocated area associated with the member to the desired region. Upon determining that an unallocated area large enough to store the second extent from the other, opposite end of the allocated area exists in the storage and is located in a desired region relative to the second extent, method 800 may proceed, at 870, to move the second extent from the allocated area.

Since an extent was moved, method 800 will proceed, at 880, to update the first and second sets of information to reflect the newly unallocated area from which the extent was moved and the newly allocated area to which the extent was moved. Data structures storing information concerning extents can also be updated.

While method 800 illustrates accessing the first set of information at 810 and accessing the second set of information at 820, in one example these sets of information may be created and stored in data structures. The data structures may be, for example, sorted lists. One skilled in the art will appreciate that other data structures are possible. The sets of information will be created from information available concerning the extent based file system and the storage.

In one example it may be desired to migrate allocated extents to the start of storage while growing unallocated areas at the end of storage. In this example, the first sorted set of information is arranged from lowest address to highest address, the second sorted set of information is arranged from highest address to lowest address, the first end is located at the highest addressed end of the allocated area associated with the member, and the second end is located at the lowest addressed end of the allocated area associated with the member. In this example, the desired region will be located before the lowest addressed extent associated with the member.

In another example, it may be desired to migrate allocated extents to the end of storage while growing unallocated areas at the beginning of storage. In this example, the first sorted set of information is arranged from highest address to lowest address, the second sorted set of information is arranged from lowest address to highest address, the first end is located at the lowest addressed end of the allocated area associated with the member, and the second end is located at the highest addressed end of the allocated area associated with the member. One skilled in the art will appreciate that other locations to aggregate extents and/or free space may be selected.

Whether an unallocated area is appropriate for receiving an extent can depend on different criteria. In one example, the appropriate area is determined based on a best fit search. Therefore, in one example, creating the first sorted set of information comprises arranging the first sorted set of information to be searchable using a best-fit search.

An extent based file system can store enormous amounts of data. Therefore, to defragment free space may involve swapping an enormous number of extents and unallocated areas. Performing the desired number of swaps may not be achievable in a relevant time frame using a single process. Therefore, in one example, method 800 may include controlling two or more processes associated with a distributed file system to move extents in parallel. By way of illustration, two or more extents to be moved and two or more unallocated areas to receive the extents can be identified. Method 800 could then control two or more processes to perform the swaps.

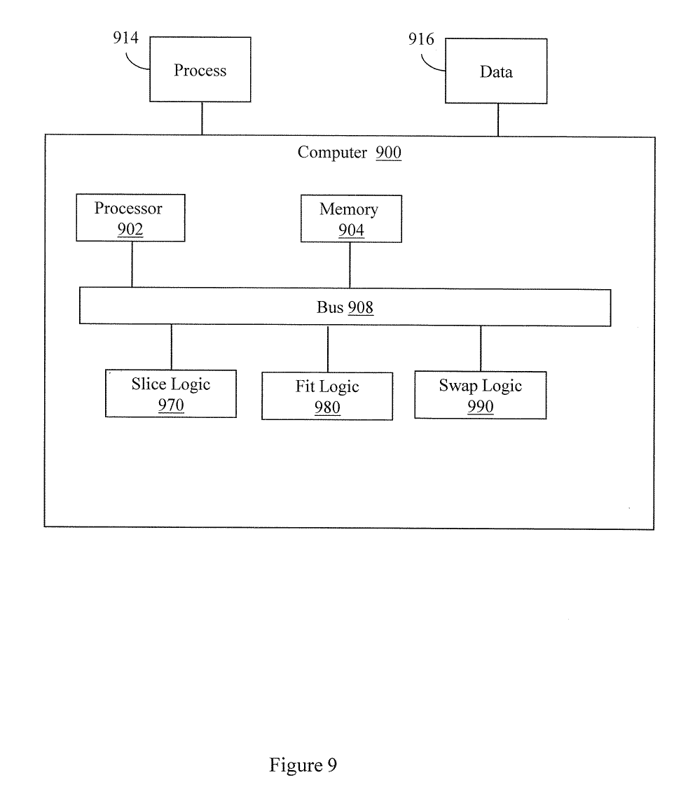

FIG. 9 illustrates a computer 900. Computer 900 includes a processor 902 and a memory 904 that are operably connected by a bus 908. In one example, the computer 900 may include a slice logic 970, a fit logic 980, and a swap logic 990. The slice logic 970 is configured to identify an extent to slice away from an end of an allocated region. The slice logic 970 may start slicing at the front of an allocated region or at the end of an allocated region. The allocated region stores extents in a storage storing files for an extent based file system. The fit logic 980 is configured to identify an unallocated region in the storage to receive the extent. The unallocated region needs to satisfy a size criteria and a location criteria before being selected. In one example, the unallocated region satisfies the size criteria when the unallocated region is the result of a best fit search of unallocated regions in the storage. In another example, the unallocated region satisfies the size criteria when the unallocated region is the result of a first fit search of unallocated regions in the storage. Both the best fit search and the first fit search may be controlled to search storage in a certain direction (e.g., low addresses to high addresses, high addresses to low addresses). In one example, the unallocated region satisfies the location criteria when the unallocated region maintains a desired spatial relationship between the extent and the unallocated region. For example, an unallocated region may be required to be completely before an allocated region from which an extent is being moved or an unallocated region may be required to be completely after an allocated region from which an extent is being moved.

The computer 900 also includes a swap logic 990 that is configured to swap the extent and the unallocated region as a transaction. Swapping the extent and the unallocated region as a transaction, where the moves are either all done or not done at all, facilitates reducing coherency issues in the storage. The swap logic 990 is configured to keep an extent intact as a single entity.

In one example, the computer 900 also includes a parallel logic that is configured to control the slice logic 970 and the fit logic 980 to identify two or more extents to be swapped with two or more unallocated regions. Rather than swapping an extent and an unallocated region immediately upon finding a suitable swap pair, the parallel logic may control the swap logic 990 to control two or more processes to swap the two or more extents in parallel.

Generally describing an example configuration of the computer 900, the processor 902 may be a variety of various processors including dual microprocessor and other multi-processor architectures. A memory 904 may include volatile memory (e.g., RAM (random access memory)) and/or non-volatile memory (e.g., ROM (read only memory)). The memory 904 can store a process 914 and/or a data 916, for example. The process 914 may be a data reduction process and the data 916 may be an object to be data reduced.

The bus 908 may be a single internal bus interconnect architecture and/or other bus or mesh architectures. While a single bus is illustrated, it is to be appreciated that the computer 900 may communicate with various devices, logics, and peripherals using other busses (e.g., PCIE (peripheral component interconnect express), 1394, USB (universal serial bus), Ethernet). The bus 908 can be types including, for example, a memory bus, a memory controller, a peripheral bus, an external bus, a crossbar switch, and/or a local bus.

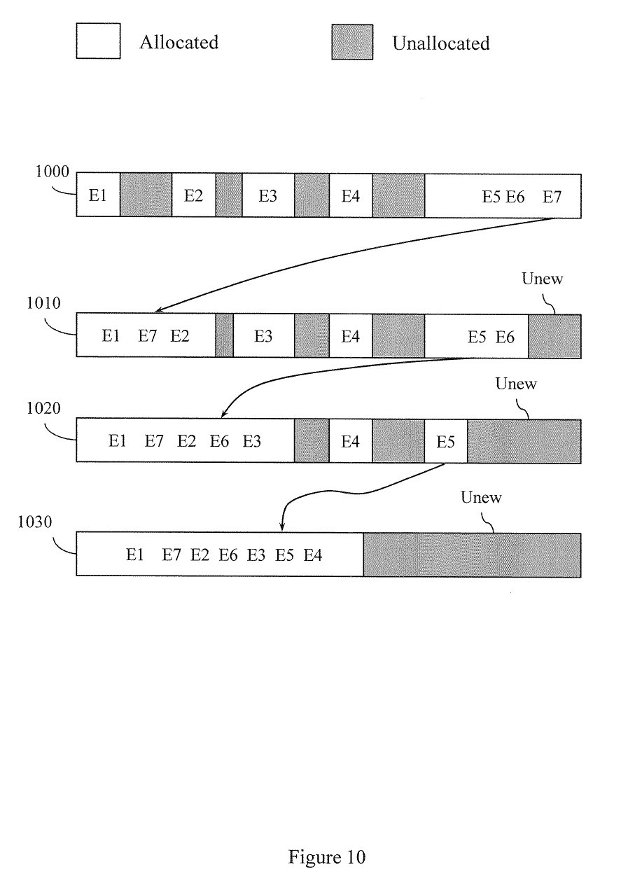

FIG. 10 illustrates allocated areas and unallocated areas in a storage associated with an extent-based file system. At a time 1000, there are four unallocated areas. Example apparatus and methods can operate on the allocated areas and unallocated areas using, for example a best fit approach. Between time 1000 and 1010, extent E7 is sliced off the end of an allocated area and inserted into the best fitting area located between E1 and E2. After the slice and move there are still four unallocated areas, including a new area Unew. Between time 1010 and 1020, extent E6 is then sliced off the end of an allocated area and inserted into the best fitting area between E2 and E3. Between time 1020 and 1030, extent E5 is then sliced out of the allocated area and inserted into the best fitting area between E3 and E4. These slices are placed into the receiving areas based on satisfying best fit criteria.

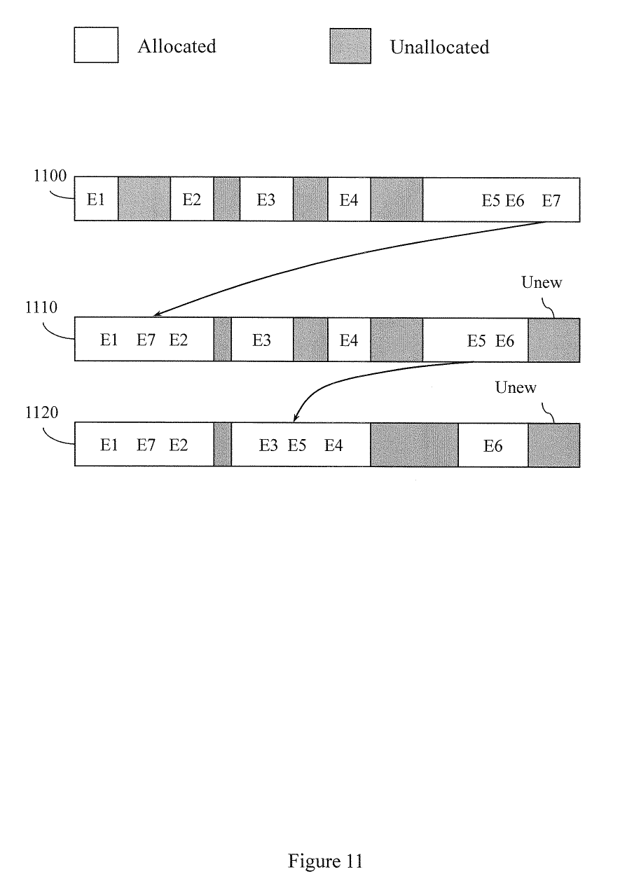

FIG. 11 illustrates allocated areas and unallocated areas in a storage associated with an extent-based file system and demonstrates that a slice may not be moved to the first available location but rather to the best fitting location. Between time 1100 and 1110, extent E7 is sliced off the back of an allocated area and inserted into the best fitting area between E1 and E2. Then, between time 1110 and 1120, extent E5 is sliced out of the allocated area and inserted into the best fitting area, which appears between E3 and E4, not between 2 and E3.

While example apparatus, methods, and articles of manufacture have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. An article of manufacture, comprising:
a computer readable medium storing computer executable instructions that when executed by a computer control the computer to perform a free space defragmentation method for free space in a storage associated with an extent-based file system, the method comprising:
upon locating a first unallocated area having a desired size and a desired location to receive an extent from a first end of an allocated area in the storage, swapping the extent from the first end of the allocated area with the first unallocated area; and
upon locating a second unallocated area having a desired size and a desired location to receive an extent from a second opposite end of the allocated area in the storage, swapping the extent from the second end of the allocated area with the second unallocated area.

2. The article of manufacture of claim 1, where the first unallocated area and the second unallocated area are determined as a function of a best fit selection strategy and where the first unallocated area and the second unallocated area are determined as a function of a spatial relationship with the allocated area.

3. The article of manufacture of claim 1, where the extent-based file system is a distributed file system.

4. The article of manufacture of claim 1, the method comprising:
identifying two or more extents to be swapped from the allocated area to an unallocated area; and
controlling two or more processes to swap the two or more extents in parallel as a transaction.

5. The article of manufacture of claim 1, the method comprising:
repeatedly identifying unallocated areas to receive extents and swapping extents to the unallocated areas until no more unallocated areas suitable for receiving an extent are available.

6. An article of manufacture, comprising:
a computer readable medium storing computer executable instructions that when executed by a computer control the computer to perform a method, the method comprising:
accessing a first sorted set of information that describes unallocated areas in a storage associated with a distributed extent-based file system;
accessing a second sorted set of information that describes allocated areas in the storage, where a member of the second set of information includes identifiers of one or more extents in an allocated area of the storage associated with the member; and
repeating, while more than a threshold number of extents are moved from an allocated area of the storage to an unallocated area of the storage during a pass through the following actions:
```
{
  repeating, for members of the second set of information, while more than a threshold
  number of extents are moved from an allocated area of the storage associated with a
  member to an unallocated area of the storage during a pass through the following actions:
  (
    selecting a member of the second sorted set of information;
    selecting a first extent associated with the member, where the first extent is the
    terminal extent at a first end of the allocated area associated with the member; and
    upon determining that an unallocated area large enough to store the first extent
    exists in the storage and is located in a desired region relative the first extent in
    storage:
      selectively moving the first extent from the first end of the allocated area
      associated with the member to the unallocated area in the desired region;
      updating the first and second sets of information to indicate that the
      allocated area from which the first extent was moved is now an
      unallocated area;
      removing the first extent from the member;
      updating the first and second sets of information to indicate that the
      unallocated area to which the first extent was moved is now an allocated
      area;
      adding the first extent to a member of the second set of information
      corresponding to the allocated area to which the first extent was moved;
      selecting a second extent associated with the member, where the second
      extent is the terminal extent at a second, opposite end of the allocated area
      associated with the member; and
      upon determining that an unallocated area large enough to store the second
      extent exists and is located in the desired region in the storage:
        selectively moving the second extent from the allocated area
      associated with the member to the unallocated area in the desired region;
        updating the first set of information to indicate that the allocated
      area from which the second extent was moved is now an unallocated area;
        removing the second extent from the member;
        updating the first set of information to indicate that the unallocated
      area to which the second extent was moved is now an allocated area; and
        adding the second extent to a member of the first set of information
      corresponding to the allocated area to which the second extent was moved;
    )
  }.
```

7. The article of manufacture of claim 6, the method comprising:
creating the first sorted set of information from information available concerning the extent based file system and the storage; and
creating the second sorted set of information from information available concerning the extent based file system and the storage.

8. The article of manufacture of claim 6,
where the first sorted set of information is arranged from lowest address to highest address;
where the second sorted set of information is arranged from highest address to lowest address;
where the first end is located at the highest addressed end of the allocated area associated with the member; and
where the second end is located at the lowest addressed end of the allocated area associated with the member.

9. The article of manufacture of claim 8, where the desired region is located before the lowest addressed extent associated with the member.

10. The article of manufacture of claim 8, where the desired region is located after the highest addressed extent associated with the member.

11. The article of manufacture of claim 6,
where the first sorted set of information is arranged from highest address to lowest address;
where the second sorted set of information is arranged from lowest address to highest address;
where the first end is located at the lowest addressed end of the allocated area associated with the member; and
where the second end is located at the highest addressed end of the allocated area associated with the member.

12. The article of manufacture of claim 7,
where creating the first sorted set of information comprises arranging the first sorted set of information to be searchable using a best-fit search.

13. The article of manufacture of claim 12, where the desired region is selected using a best-fit search.

14. The article of manufacture of claim 7,
where extents associated with a member of the second sorted set of information are sorted in increasing physical block order.

15. The article of manufacture of claim 6, where the storage is one or more of, a memory, a disk, and a tape.

16. The article of manufacture of claim 6, the method comprising:
controlling two or more processes associated with a distributed file system to swap, in parallel, extents and unallocated areas.

17. An apparatus, comprising:
a processor;
a memory; and
an interface that connects the processor, the memory, and a set of logics, the set of logics comprising:
a slice logic configured to identify an extent to slice away from an end of an allocated region, where the allocated region stores one or more extents in a storage storing files for an extent based file system;
a fit logic configured to identify an unallocated region in the storage to receive the extent, where the unallocated region satisfies a size criteria and a location criteria; and
a swap logic configured to swap the extent and the unallocated region as a transaction, where the extent remains intact as a single entity, and where the extent moves in a desired direction in the storage.

18. The apparatus of claim 17, where the unallocated region satisfies the size criteria when the unallocated region is the result of a best fit search of unallocated regions in the storage.

19. The apparatus of claim 17, where the unallocated region satisfies the location criteria when the unallocated region maintains a desired spatial relationship between the extent and the unallocated region.

20. The apparatus of claim 17, comprising:
a parallel logic configured to control the slice logic and the fit logic to identify two or more extents to be swapped with two or more unallocated regions and to control the swap logic to control two or more processes to swap, in parallel, the two or more extents and the two or more unallocated regions.
